(19) United States
(12) Patent Application Publication
(10) Pub. No.: US 2011/0141083 A1
(43) Pub. Date: Jun. 16, 2011

(54) Cell Phone

(76) Inventors: WEI-HUA LU, TAIPEI (TW); CHIH-KUEI HU, JUBEI (TW); WEI-TING LIU, HACIENDA HEIGHTS, CA (US)

(21) Appl. No.: 12/639,949

(22) Filed: Dec. 16, 2009

(51) Int. Cl. G09G 5/00; G09G 3/34

(52) U.S. Cl. 345/211; 345/107

(57) ABSTRACT

A cell phone is disclosed. The cell phone includes a housing, an inner circuit, placed inside the housing, for providing communication functions, and a display, electrically connected to the inner circuit, for displaying communication information; a power supply, placed inside the housing. The housing includes a first bi-stable electro-phoretic display, on the outer of the housing, for displaying an image. The power supply is electrically connected to the display, the inner circuit, and the first bi-stable electro-phoretic display, for supplying power to the display, the inner circuit, and the first bi-stable electro-phoretic display.

### BACKGROUND OF THE INVENTION

1. Field of the Invention

The present invention relates to a cell phone, and more particularly, to a cell phone using e-paper as its display or external surface.

2. Description of the Prior Art

A cell phone, undoubtedly, is one of the most popular electronic devices in this modern world. Cell phones allow users to communicate with others whenever they want. This advantage of the cell phones does help the development of business because businessman can reduce more time in communications.

Furthermore, in nowadays, the cell phone is not just a communication tool. Instead, it becomes a personalized product. Its appearance is a representative of tastes and brands. Therefore, the cell phone manufacturers all work hard to make new designs of cell phones, and try to attract consumers by their good looking. In this way, various housings or cell phone shapes are published such that the consumers can choose their favorites.

Please refer to FIG. 1, which depicts cell phones 10, 20 having different appearances according to the prior art. As shown in FIG. 1, the cell phones 10, 20 have different appearances because of their housings 101, 201. Therefore, if the consumers get tired of the appearance of their cell phones, the only solution is to change the housings or the entire cell phones (e.g. buy a new one). Obviously, this is not economical, and is not environmental.

In addition, the most essential characteristic of the cell phone is its power consumption. The power consumption directly relates its stand-by time and talk time. As is known, although the LCD display screen can display images having good image qualities, it's not power-saved product because it consumes power to frequently refresh the images on the screen in order to maintain the displayed images. Therefore, this makes the cell phone spend more power, and becomes inconvenient for users.

### SUMMARY OF THE INVENTION

It is therefore a primary objective of the claimed invention to provide a cell phone using e-paper as its display screen or its external surface.

According to an objective of the present invention, a cell phone is disclosed. The cell phone comprises: a housing comprising: a first bi-stable electro-phoretic display, on the outer of the housing, for displaying an image; an inner circuit, placed inside the housing, for providing communication functions, and a display, electrically connected to the inner circuit, for displaying communication information; a power supply, placed inside the housing, the power supply electrically connected to the display, the inner circuit, and the first bi-stable electro-phoretic display, for supplying power to the display, the inner circuit, and the first bi-stable electro-phoretic display.

According to another objective of the present invention, a cell phone is disclosed. The cell phone comprises: an antenna module, for receiving communication signals; an inner circuit, for processing the communication signals and generating the communication information according to the communication signals; a memory, for temporarily storing data; a power supply, for supplying power; an electro-phoretic display, for displaying information; wherein the electro-phoretic display consumes power supplied from the power supply at a plurality of predefined time points to update the information, and the electro-phoretic display maintain the information without consuming any power at least for a second.

According to another objective of the present invention, a method for driving an electro-phoretic display of a cell phone is disclosed. The cell phone comprises a housing including the electro-phoretic display on the outer of the housing, an inner circuit for providing communication functions, a LCD display, and a power supply, and the method comprises: supplying power to the LCD display, the inner circuit, and the electro-phoretic display; wherein the LCD display consumes power supplied from the power supply for displaying communication information, and the electro-phoretic display consumes power supplied from the power supply only when an image displayed on the electro-phoretic display is being updated.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 depicts cell phones having different appearances according to the prior art.

FIG. 2 is a diagram of a cell phone according to a first embodiment of the present invention.

FIG. 3 is a functional block diagram of the cell phone shown in FIG. 2.

FIG. 4 is a diagram of the cell phone showing clock information.

FIG. 5 is a diagram of a cell phone according to a second embodiment of the present invention.

FIG. 6 is a functional block diagram of the cell phone shown in FIG. 5.

### DETAILED DESCRIPTION

It has been suggested that electro-optical elements for converting an electrical action into an optical action be used as display devices of various types of electronic apparatuses, such as monitor, mobile phone or PDAs (Personal Digital Assistants). Electro optic Electro-phoretic displays, or called electronic paper, comprise a layer of electro-phoretic material, a term which is used herein in its conventional meaning in the imaging art to refer to a material having first and second display states differing in at least one optical property, the material being changed from its first to its second display state by application of an electric field to the material.

To obtain a high resolution electro-phoretic display, a two-dimensional addressing scheme with a plurality of data lines and a plurality of select lines is a way to achieve that requirement. In this scheme, each pixel is defined by the intersection of one data line and one select line. A pixel is connected via a non-linear element (transistor or diode) to drive circuitry used to control the operation of the display. One row (it is here assumed that the select lines define the rows of the matrix and the data lines define the columns, but obviously this is arbitrary, and the assignments could be reversed if desired) of pixels is selected by applying a voltage to a specific select line, and the voltages on the data or column lines are adjusted to provide the desired optical response from the pixels in the selected row. The pixel electrodes in the selected row are thus raised to voltages which is close to but (for reasons explained below) not exactly equal to the voltages on their associated data lines. The next row of pixels is then selected by applying a voltage to the next select line, so that the entire display is written on a row-by-row basis.

When the non-linear elements are transistors (typically thin film transistors (TFTs)), it is conventional practice to place the data and select lines, and the transistors, on one side of the electro-phoretic medium, and to place a single common electrode, which extends across numerous pixels, and typically the whole display, on the opposed side of the electro-phoretic medium. The common electrode is normally provided on the viewing surface of the display (i.e., the surface of the display which is seen by an observer). During writing of the display, the common electrode is held at a fixed voltage, known as the “common electrode voltage” or “common plane voltage” and usually abbreviated “V.sub.COM”. This common plane voltage may have any convenient value, since it is only the differences between the common plane voltage and the voltages applied to the various pixel electrodes which affects the optical states of the various pixels of the electro-phoretic medium. Most types of electro-phoretic media are sensitive to the polarity as well as the magnitude of the applied field, and thus are necessary to be able to drive the pixel electrodes at voltages both above and below the common plane voltage. For example, the common plane voltage could be 0, with the pixel electrodes varying from −V to +V, where V is any arbitrary maximum voltage. Alternatively, it is common practice to hold the common plane voltage at +V/2 and have the pixel electrodes vary from 0 to +V.

One important application of electro-phoretic media is in portable electronic devices, where battery life is an important consideration, and thus it is desirable to reduce the power consumption of the display as much as possible. Liquid crystal displays are not bistable, and hence an image written on such a display must be constantly refreshed if the image is to remain visible. The power consumed during such constant refreshment of an image is a major drain on the battery. In contrast, an electro-phoretic display only needs be written once, and thereafter the bistable medium will maintain the image for a substantial period without any refreshing, thus greatly reducing the power consumption of the display.

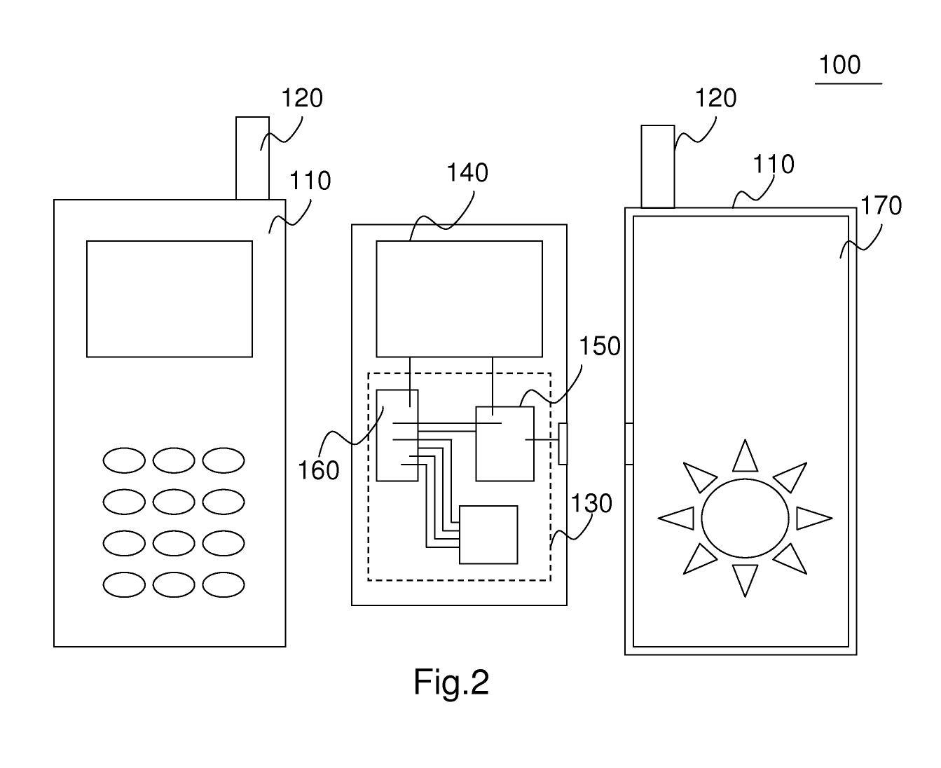

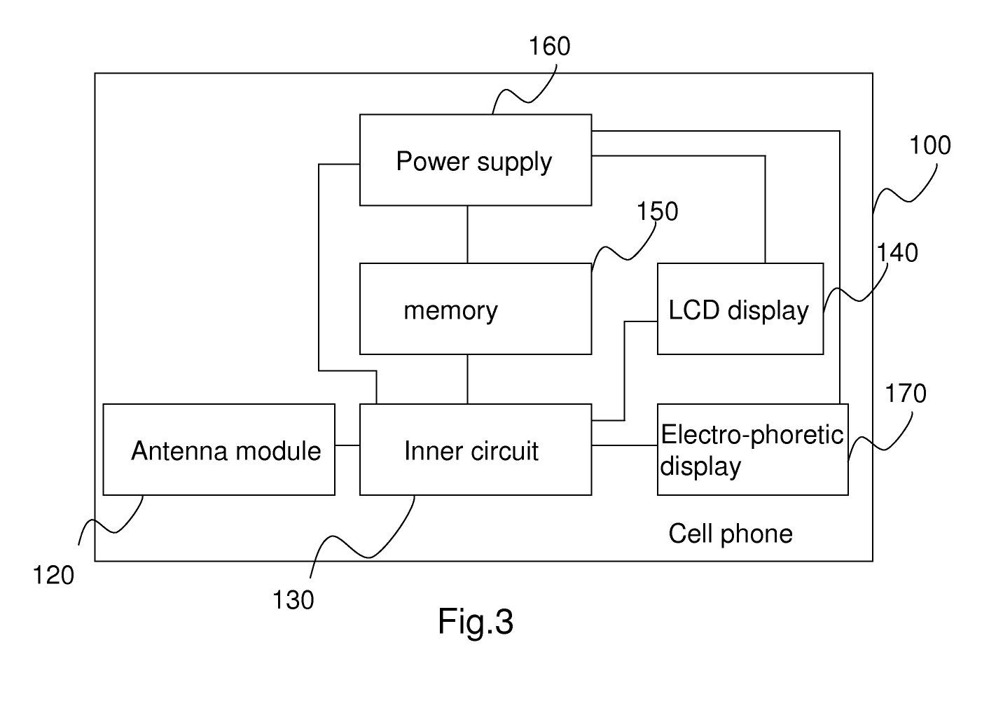

Please refer to FIG. 2 and FIG. 3. FIG. 2 is a diagram of a cell phone 100 according to a first embodiment of the present invention. FIG. 3 is a functional block diagram of the cell phone 100 shown in FIG. 2. As is shown in FIG. 2 and FIG. 3, the cell phone 100 comprises a housing 110, an antenna module 120, an inner circuit 130, an LCD display screen 140, a memory 150, and a power supply 160. The inner circuit 130, the memory 150, and the power supply 160 are placed inside the housing 110, for providing a basic communication function of the cell phone 100. Furthermore, the housing 110 has a window, for allowing the LCD display screen 140 to display image through the window.

The antenna module 120 is used to receive communication signals, and can be protruding type or concealing type. The inner circuit 130 is used to process the communication signals and generating the communication information according to the communication signals such that the inner circuit 130 can provide the communication function. The memory 150, as is known, is used to temporarily storing data, such as phone book, pictures, or other personal information. The LCD display screen 140 is used to display the above-mentioned communication information, phone books, pictures, or other personal information.

In addition, the power supply 160 is coupled to the inner circuit 130 and the memory 150, for supplying power to these components such that they can work normally.

Please note, in this embodiment, the cell phone 100 further comprises an electro-phoretic display 170. The electro-phoretic display is placed on the outer of the housing 110. In a preferred embodiment, the electro-phoretic display 170 covers the housing 110.

Please note, in this embodiment, the electro-phoretic display 170 can be used to display an image (pattern) as the appearance of the cell phone 100. For example, the electro-phoretic display 170 can display a decorative image or a user-defined image. And these images can be previously stored inside the memory 150 and are read by the inner circuit 130 and then provided to the electro-phoretic display 170. Furthermore, if the user gets tired of the appearance of the cell phone 100, the user can use his favorite image to renew the image displayed by the electro-phoretic display 170. In this way, if the user wants to change the appearance of the cell phone 100, the user does not need to replace the entire housing. Instead, the user only needs to renew the image displayed by the electro-phoretic display 170.

In addition, the power supply 160 is further coupled to the LCD display 140 and the electro-phoretic display 170 for supplying power to the LCD display 140 and the electro-phoretic display 170. Please note, the power-supplying policies of the LCD display 140 and the electro-phoretic display 170 are quite different.

Because of the bi-stable characteristic of the electro-phoretic display 170, the electro-phoretic display 170 can maintain the image without consuming any power. In contrast to the LCD display, the LCD display needs power to refresh the image frequently in order to maintain the displayed image. Therefore, the policies of supplying power are quite different in this embodiment. For the LCD display 140, the power supply 160 needs to supply power to the LCD display 140 continuously. For example, the power supply 160 periodically supplies the power to the LCD display 140 to prevent the liquid crystal from being polarized.

Please note, in above embodiment, the LCD display is used as the main screen of the cell phone. But this is only an embodiment, not a limitation of the present invention. In another embodiment, other displays such as OLED display, AMOLED display, PMOLED display can be used to replace the LCD display. Since the OLED display, AMOLED display, PMOLED display are also continuously-powered, the above-mentioned power supply policy can be used, also. These changes also obey the spirit of the present invention.

On the other hand, in a preferred embodiment, for the electro-phoretic display 170, the power supply 160 supplies the power to the electro-phoretic display 170 only when an image displayed on the electro-phoretic display is being updated instead of supplying the power continuously. Please note, the above-mentioned power-supply strategy is only an embodiment, not a limitation of the present invention. The above-mentioned power-supply strategy is only for an optimized power-saving strategy. But in the actual implementation, the power supply 160 can supply the power to the electro-phoretic display not only when the image of the electro-phoretic display is being updated (for example, in order to adjust the image displayed on the electro-phoretic display 170 to make sure that the quality of the image is good). This change also falls within the scope of the present invention.

In addition, the image displayed by the electro-phoretic display 170 is often updated non-periodically (as mentioned previously, it can be updated according to the user's demands). Therefore, the power supply 160 has to supply the power accordingly. In this case, the power supply 160 often non-periodically supplies the power to the electro-phoretic display 170, also. Please note, the above-mentioned power supply mechanism for the electro-phoretic display 170 is only regarded as an embodiment, not a limitation of the present invention. In another embodiment, the electro-phoretic display 170 can be updated schedully.

For example, the electro-phoretic display 170 can be used to display weather information, and the weather information can be updated at a specific time point once a day. As mentioned previously, the power supply 160 supplies the power accordingly. That is, the power supply 160 also supply the power to the electro-phoretic display 170 at the specific time point once a day to renew the weather information. Therefore, in this case, the power supply 160 also supplies the power to the electro-phoretic display 170 schedully.

Please note, this concept can be broadened and be more widely used in the cell phone 100. In another embodiment, the electro-phoretic display 170 can be used to display clock information or other time-related information (e.g. calendar). In this case, the electro-phoretic display 170 is updated at specific time points to display different clock information or other time-related information. This change also obeys the spirit of the present invention.

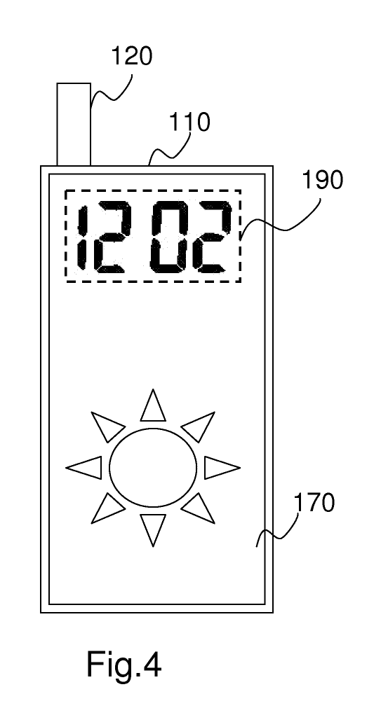

Please refer to FIG. 4, which is a diagram of the cell phone 100 showing clock information. As shown in FIG. 4, the electro-phoretic display 170 of the cell phone 100 is used to display clock information. In this case, the cell phone 100 can be used as a clock. The electro-phoretic display 170 is updated at specific time points in order to correctly display the clock information.

Please note, the present invention provides an optimized power-saving strategy for displaying the clock information. As shown in FIG. 4, the clock information only shows the hour and the minute. Therefore, the optimized power-saving strategy is to supply the power to the electro-phoretic display 170 once per minute to update the clock information.

Surely, as mentioned previously, the power supply 160 can provide the power more times to the electro-phoretic display 170 in order to ensure the image quality of the clock information.

Or, if the clock information contains seconds, the power supply 160 can provide the power accordingly (i.e. once per second). But, in this case, if the power supply provides the power once per second, the power is consumed rapidly. Therefore, the present invention recommends that the updating frequency of the electro-phoretic display should be less than once per second, to obtain a better power-consumption quality. Moreover, in an embodiment, the power supply 160 only supplies the power for four times per minute. This allows the electro-phoretic display 160 to renew the clock information every 15 seconds. This is enough for the user to know what the accurate time is.

Furthermore, in addition to the time points of supplying power, the present invention further provides another power-consuming concept. Please refer to FIG. 4 again. As shown in FIG. 4, the clock information is displayed in a dotted-line region 190. This region 190 is dedicated for the clock information. That is, if the electro-phoretic display 170 needs to update the clock information, the electro-phoretic display 170 only has to update the region 190 of the clock information instead of update the entire screen.

As is known, in a normal case, when an image is updated, the entire display screen is scanned such that every pixel of the display screen is updated. But in the above-mentioned embodiment, when the clock information is updated, only the predefined region of the clock information is scanned. It can be easily understood that this mechanism can save more power.

Moreover, as mentioned previously, the electro-phoretic display 170 can be used to display other time-related information (such as information of a calendar or a personal schedule). In this case, the power supply strategy is a little different from the above-mentioned case of displaying the clock information. For instance, a user can previously input his schedule into the cell phone 100. And the electro-phoretic display 170 can be used to remind the user.

In this case, for example, the user will hold a meeting in 15:00 and he inputs this information into the cell phone 100, and the electro-phoretic display 170 has to remind him at 14:50. The power supply does not supply power to the electro-phoretic display 170 for almost all the time, and only supplies the power to the electro-phoretic display 170 at 14:50 to allow the electro-phoretic display 170 to show the reminding information. The reminding information can be an image appearance according to that specific event of the calendar. For example, when the reminding information is a meeting, the image appearance can be an image of several people around a table; when the reminding information is someone's birthday, the image appearance can be a cake. These changes all falls within the scope of the present invention.

Please note, the implementation of above-mentioned power supplying mechanism is not hard for one having ordinary skills in this art. For example, a switch module can be implemented between the power supply 160 and the electro-phoretic display 170 to control the connection between the power supply 160 and the electro-phoretic display 170. That is, when the electro-phoretic display 170 needs to supply the power to the electro-phoretic display 170, the switch module is turned on to establish the electrical connection between the power supply 160 and the electro-phoretic display 170 such that the power supplied by the power supply 160 can be transferred to the electro-phoretic display 170. On the other hand, when the electro-phoretic display 170 does not supply the power to the electro-phoretic display 170, the switch module is turned off to break the electrical connection between the power supply 160 and the electro optic electro-phoretic display 170 such that the power supplied by the power supply 160 is interrupted.

From the above, it can be seen that the user can utilize the electro-phoretic display 170 to change the appearance of the cell phone 100 or to display weather information, clock information, or other personal information. These changes all obey the spirit of the present invention.

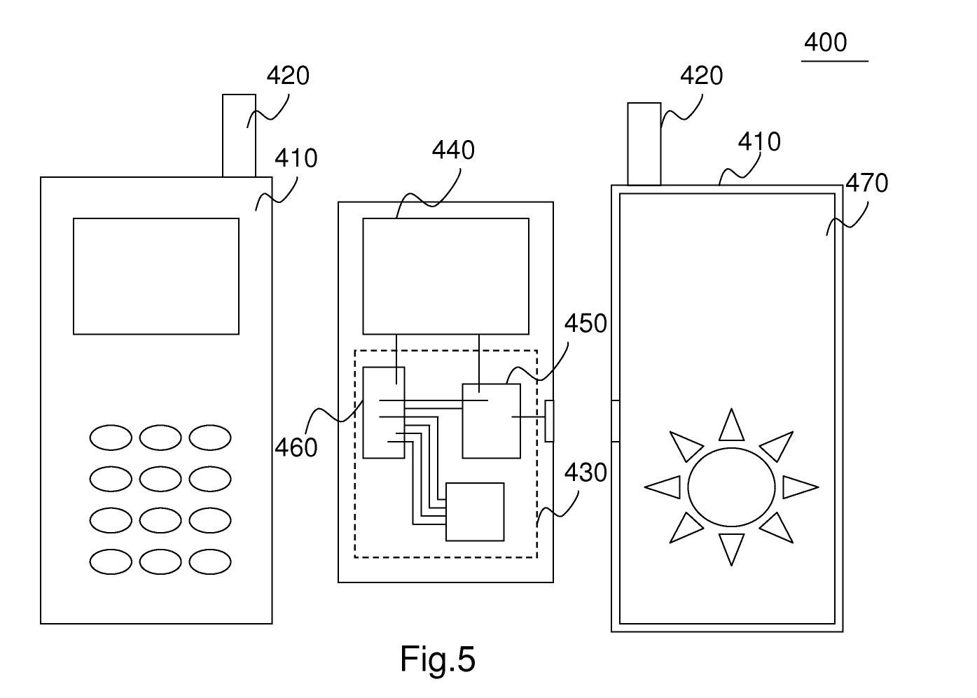

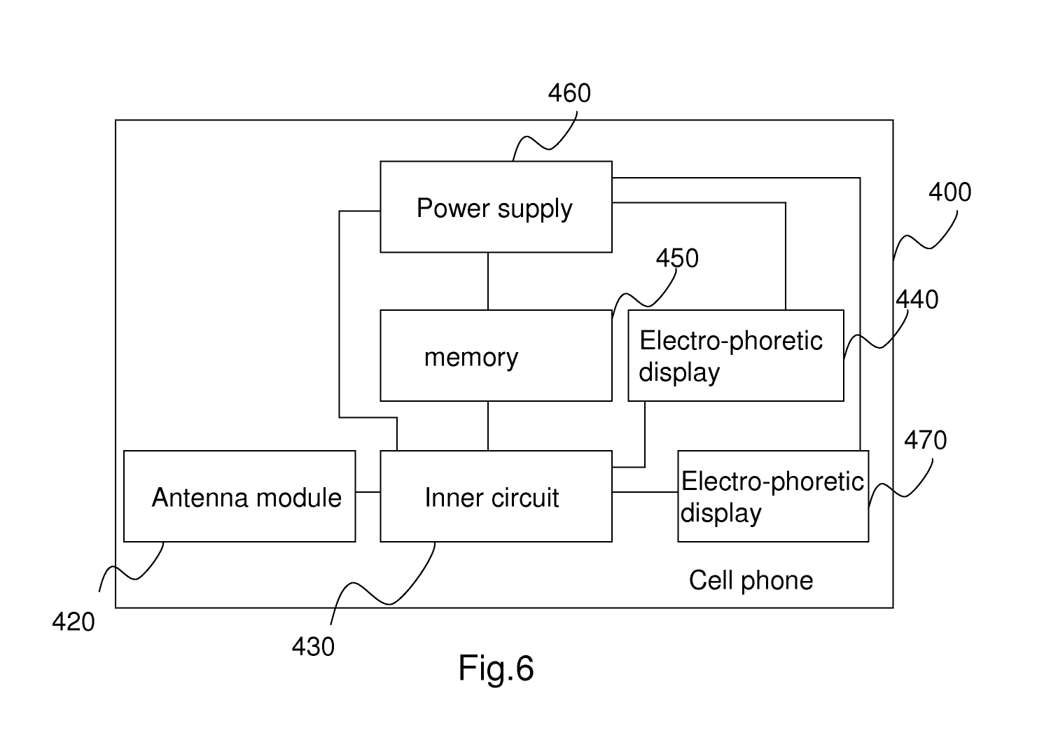

Please refer to FIG. 5 and FIG. 6. FIG. 5 is a diagram of a cell phone 400 according to a second embodiment of the present invention. FIG. 6 is a functional block diagram of the cell phone 400 shown in FIG. 4. In this embodiment, the cell phone 400 comprises a housing 410, an antenna module 420, an inner circuit 430, an electro-phoretic display 440, a memory 450, and a power supply 460. Similar to above-mentioned cell phone 100, the inner circuit 430, the memory 450, and the power supply 460 are placed inside the housing 410, for providing a basic communication function of the cell phone 400. Furthermore, an electro-phoretic display 470 is placed on the outer of the housing 410. In a preferred embodiment, the electro-phoretic display 470 covers the outer of the housing 410.

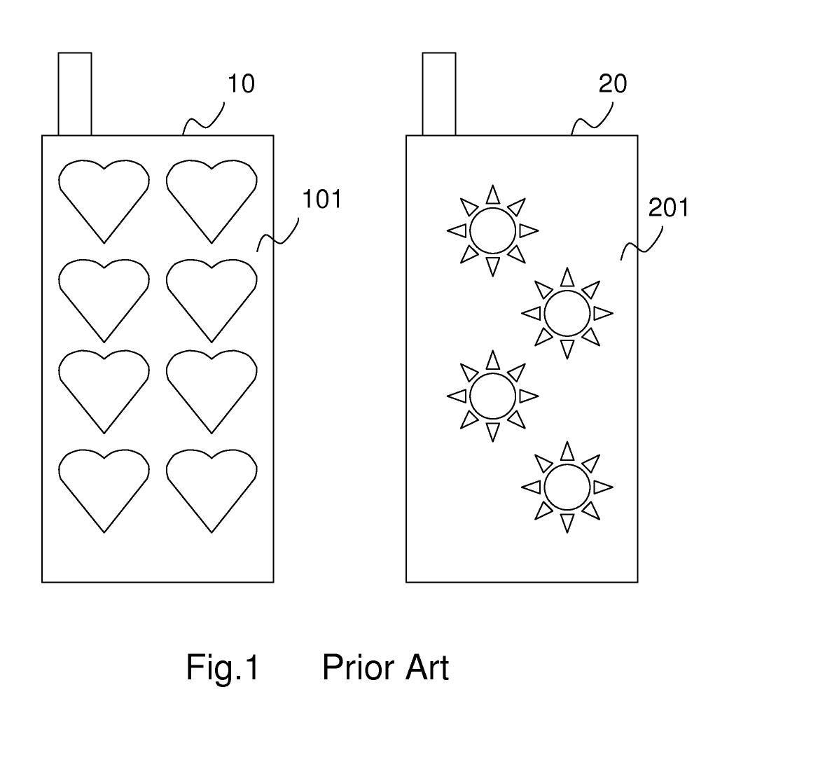

In this embodiment, the functions of the antenna module 420, the inner circuit 430, the memory 450, and the electro-phoretic display 470 are the same as those of the components having the same names in the cell phone 100 shown in FIG. 1 and FIG. 2, and thus omitted here.

Please note, the difference between the cell phone 400 and the cell phone 100 is that the cell phone 400 utilizes the electro-phoretic display 440 as its main display screen instead of using the LCD display.

According to the characteristic of the electro-phoretic display 440, the cell phone 400 can reduce more power consumption than the cell phone 100 shown in FIG. 1.

Furthermore, although the electro-phoretic display 440 is a main screen of the cell phone 400, the electro-phoretic display 440 can still be used to display clock information, weather information, or other personal information, as mentioned previously. Therefore, the power supplying strategies of the power supply 460 are quite similar to that of the power supply 160 supplying the electro-phoretic display 170.

For example, the electro-phoretic display 440 can contain a predefined region to display specific information (e.g. the clock information). And when the specific information need to be updated, only the predefined region is being updated. Furthermore, as mentioned previously, the power supply 460 can be designed to supply the power to the electro-phoretic display 440 at multiple time points (e.g. every minute or every second), to save more power.

Basically, the operation of the power supply 460 is similar to the power supply 160, and further illustration is omitted here.

Those skilled in the art will readily observe that numerous modifications and alterations of the device and method may be made while retaining the teachings of the invention.

What is claimed is:

1. A cell phone comprising:
a housing, comprising:
a first bi-stable electro-phoretic display, on the outer of the housing, for displaying an image;
an inner circuit, placed inside the housing, for providing communication functions, and
a display, electrically connected to the inner circuit, for displaying communication information;
a power supply, placed inside the housing, the power supply electrically connected to the display, the inner circuit, and the first bi-stable electro-phoretic display, for supplying power to the display, the inner circuit, and the first bi-stable electro-phoretic display.

2. The cell phone of claim 1, wherein the power supply non-periodically supplies power to the first bi-stable electro-phoretic display such that the first bi-stable electro-phoretic display non-periodically updates the image.

3. The cell phone of claim 1, wherein the power supply supplies power to the first bi-stable electro-phoretic display only when the first bi-stable electro-phoretic display updates the image.

4. The cell phone of claim 1, wherein the display is a second bi-stable electro-phoretic display.

5. The cell phone of claim 4, wherein the second bi-stable electro-phoretic display displays clock information, and the power supply supplies power to the second bi-stable electro-phoretic display once per minute such that the second bi-stable electro-phoretic display updates the clock information once per minute.

6. The cell phone of claim 1, wherein the image is a decorative image of the housing.

7. The cell phone of claim 1, wherein the image is a user-defined image.

8. A cell phone comprising:
an antenna module, for receiving communication signals;
an inner circuit, for processing the communication signals and generating the communication information according to the communication signals;
a memory, for temporarily storing data;
a power supply, for supplying power;
an electro-phoretic display, for displaying information;
wherein the electro-phoretic display consumes power supplied from the power supply at a plurality of predefined time points to update the information, and the electro-phoretic display maintain the information without consuming any power at least for a second.

9. The cell phone of claim 8, wherein the information is clock information, and the electro-phoretic display consumes power supplied from the power supply less than five times per minute such that the electro-phoretic display updates the clock information.

10. The cell phone of claim 9, wherein the electro-phoretic display consumes power supplied from the power supply once per minute such that the electro-phoretic display updates the clock information once per minute.

11. The cell phone of claim 9, wherein the power supply supplies power to the electro-phoretic display once per minute such that the electro-phoretic display updates the clock information once per minute.

12. The cell phone of claim 9, wherein the clock information is displayed in a predefined region of the electro-phoretic display, and the electro-phoretic display only updates the predefined region when updating the clock information.

13. The cell phone of claim 9, wherein the power supply supplies power less than five times per minute to the electro-phoretic display such that the electro-phoretic display updates the clock information.

14. The cell phone of claim 8, wherein the information is an time-related event of a calendar, and the electro-phoretic display consumes power supplied from the power supply at a specific time point.

15. A method for driving an electro-phoretic display of a cell phone, the cell phone comprising a housing including the electro-phoretic display on the outer of the housing, an inner circuit for providing communication functions, an LCD display, and a power supply, the method comprising:
supplying power to the LCD display, the inner circuit, and the electro-phoretic display;
wherein the LCD display consumes power supplied from the power supply for displaying communication information, and the electro-phoretic display consumes power supplied from the power supply only when an image displayed on the electro-phoretic display is being updated.

16. The method of claim 15, wherein the step of supplying power to the LCD display, the inner circuit, and the electro-phoretic display comprising:
utilizing the power supply to discontinuously supply power to the electro-phoretic display.

17. The method of claim 15, wherein the step of supplying power to the LCD display, the inner circuit, and the electro-phoretic display comprising:
utilizing the power supply to periodically supply power to the LCD display.

18. The method of claim 15, wherein the step of supplying power to the LCD display, the inner circuit, and the electro-phoretic display comprising:
utilizing the power supply to supply power to the electro-phoretic display only when an image displayed on the electro-phoretic display is being updated.
